(19) United States
(12) Patent Application Publication
(10) Pub. No.: US 2012/0134569 A1
(43) Pub. Date: May 31, 2012

(54) METHOD AND DEVICE FOR REDUCING POSITION-RELATED GRAY VALUE VARIATIONS BY MEANS OF A REGISTRATION OF IMAGE DATA SETS

(75) Inventors: Georg Schummers, Munchen (DE); Daniel Stapf, Unterschleissheim (DE); Graciela Bove Barrios, Munchen (DE)

(73) Assignee: TOMTEC IMAGING SYSTEMS GMBH, Unterschleissheim (DE)

(21) Appl. No.: 13/260,882

(22) PCT Filed: Mar. 29, 2010
(86) PCT No.: PCT/EP2010/054059

§ 371 Date: Feb. 7, 2012

(30) Foreign Application Priority Data
Mar. 31, 2009 (DE) 10 2009 015 116.8

(51) Int. Cl. G06K 9/00

(52) U.S. Cl. 382/133

(57) ABSTRACT

The present invention relates to a device and to a method for reducing in particular position-related gray value variations of image data sets of an object (18), in particular of a heart, which are recorded in various first layers (SA1, SA2, . . . , SAn) as respective first pictures (SP1, SP2, . . . , SPn) and in at least one second layer (LA1) intersecting with at least one first layer (SA1, SA2, . . . , SAn) as a respective second picture (LP1), comprising the following steps:
registering the respective first pictures (SP1, SP2, . . . , SPn) of the first layers (SA1, SA2, . . . , SAn) relative to each other and with the at least one second picture (LP1) of the at least one second layer (LA1) in order to associate the first pictures (SP1, SP2, . . . , SPn) and the at least one second picture (LP1) of the object (18) with each other, and
adjusting respective gray values of the object (18) in the at least one second picture to the respective gray values of the object (18) in the first pictures (SP1, SP2, . . . , SPn) based on a reference-oriented adjustment scheme, wherein the reference-oriented adjustment scheme especially considers or is limited to the intersection area of the respective first picture (SP1, SP2, . . . , SPn) with the at least one second picture (LP1).

The present invention relates to a method for reducing in particular system-related and position-related gray value variations by registering image data sets according to claim 1, a computer program product therefor according to claim 11, a data carrier according to claim 12, on which such a computer program product is stored, as well as a corresponding imaging device according to claim 13.

For image recording methods as they are used in medical engineering for example, where two-dimensional images are recorded in different layers, wherein at least one layer intersects with the remaining layers, and where from said two-dimensional layers a three-dimensional image is reconstructed, a registration of the individual layers with each other as well as of the intersecting layer(s) is necessary. In layer-wise recording methods, it may happen that identical structures are represented with different gray values. This often occurs in particular in magnetic resonance imaging due to the non-exact homogeneity of the magnetic field of the MRI scanner or due to changes in the position of body parts of the patient. Thus, for example for cMR sequences (cardiac magnetic resonance tomography) the image is recorded layer-wise over several heart cycles. During this image recording time, there are usually random or breathing-induced movements by the patient. Due to said movements, possibly in combination with the mentioned inhomogeneity, it is possible that different gray values are attributed to the same structure in the individual long-axis layers and short-axis layers. For a reliable evaluation of the perfusion of the heart muscle, for example, it is mandatory that such gray value variations be corrected. Moreover, such gray value variations cause undesired artifacts, for example during volume rendering, in particular in perfusion evaluation.

From Khurshid, K., et al.: “Automated Software for PET/CT Image Registration to Avoid Unnecessary Invasive Cardiac Surgery”; IEEE Multitopic Conf., INMIC '06, 2006, pages 498-503 it is known to register PET images and CT images which have position-related gray value variations relative to each other by attributing first pictures of the PET images to second pictures of the CT images, by at first bundling them via a fuzzy function and then overlaying them by means of a motion vector. The motion vector is determined by means of an edge detection of regions of interest.

A basic way of registering two images is disclosed in US 2006/0029291 A1. This document describes how, due to deviations or common or similar image information (mutual information), two images may be attributed to each other. To this end, one of the images is at first adapted to the other image in order to be able to make a comparison, then identical or similar image contents are extracted and attributed (compound mutual information). Then, the adaption of the one image is repeated until the approximation is sufficiently exact.

In order to solve said problems, there exist several approaches by means of bias field estimation, however said methods are an estimation or approximation. For example, it is inherent in the method of perfusion that there are desired inhomogeneities in the gray value distribution, which are due to a respective accumulation of contrast agent, from which it is intended to get hints to the blood flow or perfusion of the heart muscle, for example. Therefore, said methods are unsuitable. Moreover, up to now, the layers acquired by this method are diagnosed individually, i.e. in the two-dimensional, not in the three-dimensional context. The problem of non-correct gray values occurs more intensely when the data is to be evaluated three-dimensionally or four-dimensionally. However, such a three-dimensional or four-dimensional evaluation is very advantageous since it makes it possible to achieve a substantially higher spatial resolution and, hence, a better spatial context. Two-dimensional layers reflect only a respective part of the area to be examined.

Moreover, it should be noted that gray values are attributed to the measured values. The measured values may represent substances or tissue types such as bones, blood, contrast agent, etc. Therefore, it is important for the evaluation that the gray values are not unnecessarily distorted.

In order to be able to carry out a three- or four-dimensional evaluation, it is necessary to register at first the two-dimensional images in the different sectional planes relative to each other, and from the registered two-dimensional images three- or four-dimensional images have to be reconstructed. Here, up to now the reconstruction is carried out as follows: in case the same structure has different gray values in the two-dimensional images, an interpolation of the gray values is carried out on a pixel-by-pixel or voxel-by-voxel basis in the two-dimensional images in order to obtain corresponding gray values in the three- or four-dimensional images.

As a result, the three- or four-dimensional evaluations are artifact-afflicted with respect to morphology and function. This means that the interpolation leads to gray values which no longer unambiguously correspond to certain structures such as blood, bones, blood vessels or other distinguishable structures.

Therefore, the object underlying the present invention is to provide a method, wherein, in the three-dimensional or four-dimensional representation of objects, artifacts are largely reduced or even avoided so as to make it possible to evaluate the pictures of said objects as accurately as is possible. Moreover, the present invention is to provide a corresponding computer program or computer program product, possibly stored on a data carrier, as well as a corresponding imaging device.

These objects are achieved by means of a method for reducing system-related and/or position-related gray value variations of image data sets of an object according to claim 1, a corresponding computer program product according to claim 11, a data carrier according to claim 12, or an imaging device according to claim 13. Advantageous further developments of the invention are defined in the dependent claims.

According to the invention, the procedure is as follows in the case of the image data sets of the object, which are recorded in different first layers as respective first pictures and in at least one second layer intersecting with the first layers as respective second picture: the respective first pictures of the first layers are registered relative to each other and then registered with the one second picture or several second pictures of the one or several second layers so that the first pictures in the first layers and the respective second pictures in the second layers are attributed to or associated with one another so that said pictures overlay or coincide as far as is possible. This means that an unambiguous attribution of common structures is obtained. In order to make sure that not only the structures in the first pictures and the at least one second picture are attributed, but also the respective gray values not only “fit together”, but are not unnecessarily distorted and lead to artifacts, the respective gray values are not individually interpolated, as is the case in the prior art, but the respective gray values of the object in the second picture are adjusted to the respective gray values in the first pictures on the basis of a reference-oriented adjustment scheme—to which end it can be advantageous to use a common reference value or base value.

This means that, to put it differently, the gray value is adjusted by means of interpolation not for each pixel/voxel separately, i.e. pixel by pixel/voxel by voxel, as is the case in the prior art, but the gray values of the pixels/voxels in a layer or picture, respectively, are adjusted to the gray values of the pixels/voxels of the respective other layer or picture, respectively, for the entire image using the reference-oriented adjustment scheme, so that the gray values in the one picture are adapted to those in the other picture. Although such a registered and adjusted image may become too light or too dark, for example, this procedure ensures that the pixels/voxels of an image are not distorted relative to each other. Thus, it is possible to largely avoid artifacts.

The respective gray values of the object in the at least one second picture are preferably adjusted to the respective gray values of the object or structure, respectively, in the first pictures by using the information at the “point of intersection” as a “reference-oriented adjustment scheme” for an overall adaption of the at least one second picture to the first pictures. Here, the reference-oriented adjustment scheme takes account of the point or area of intersection of the respective first picture with the at least one second picture or it is even limited thereto.

The “point of intersection” or the area of intersection is either the intersection lines which result from the intersection of the respective first picture with the at least one second picture or an extended area around said intersection lines, which may be set accordingly.

Preferably, there is used for the reference-oriented adjustment scheme the respective mean value of the gray values in the area of intersection of the respective first picture with the at least one second picture, in particular its two-dimensional intersection line or three-dimensional intersection volume, respectively.

Alternatively, it is also possible to use for the reference-oriented adjustment scheme the mean value of the gray values in the areas of intersection of some or all of the first pictures with the one or several second picture(s). Instead of the mean value it is also possible to chose the difference value in the area of intersection.

It is particularly preferred that the first layers form a short-axis stack of a random chamber of a heart and that the at least one second layer forms a long-axis section of said chamber of the heart. As a matter of course, also two or three long-axis sections may be present. In this case, thus, a preferred procedure is to adjust or adapt the gray values of said common structures in the long axes to the gray values of said common structures in the short axes. As a matter of course, however, also the opposite approach is possible in that the gray values of the common structures are adjusted or adapted in the short axes to the gray values of the common structures in the long axes by means of the reference-oriented adjustment scheme.

The method according to the invention may be advantageously employed when the random chamber of the heart is the left ventricle.

The result of registration may still be improved if prior to the registration of the respective first pictures relative to each other a so-called pre-processing is carried out. A further improvement is possible if said pre-processing is carried out also prior to the registration of the registered first pictures with the at least one second picture. Said pre-processing represents a prior processing of the image data and comprises in particular the filtering of the image data, for example in order to remove noise.

It is particularly preferred that the adjustment is carried out with histogram-based operations—i.e. concerning always the entire image or at least an image section thereof. Among said histogram operations are counted inter alia the following known methods: Otsu's method, contrast stretching, contrast steepening, changing the gradation curves.

Preferably, when registering the first pictures with the at least one second picture intersecting with the at least one first layer, a respective intersection line or a respective intersection volume is calculated, both in the first picture in question and in the second picture in question, and on these two intersecting lines or intersection volumes the respective gray values are extracted. The extracted gray values are here treated as an image, so that a comparison measurement between the two images is calculated. Here, it makes sense to use preferably the generally accepted standard method of mutual information as a comparison measurement. As a rule, for the calculation of the comparison measurement—which often is referred to as similarity measurement or metric—there are used many intersection lines or intersection volumes, respectively, in the first pictures in question and in the second pictures in question.

In general, the procedure is to check whether the comparison measurement has a certain minimum quality or is already optimal. If this is not the case, i.e. the comparison measurement fulfills a criterion for repeating the registration, when the registration of the first pictures with the at least one second picture will be repeated. This is followed by as many repetitions as are necessary until the comparison measurement has the desired quality. As a criterion for repetition it may be considered, for example, whether the comparison measurement is below a certain threshold value, whether between two iterations or repetitions of the registration only changes occur which are below a certain threshold value or if no more changes at all are detectable.

It is preferred to allow only small changes in the method according to the invention, in particular when adjusting the gray values, and to recursively carry out the registration and the gray value adjustment. In the method according to the invention, the changes are preferably adjusted adaptively.

According to the invention this object is also achieved by a computer program or computer program product for carrying our one of the aforementioned methods, which program runs on a control and evaluation system of an imaging device for providing three-dimensional or four-dimensional images of an object with reduced position-related gray value variations. The invention relates further to a data carrier on which a corresponding computer program product is stored.

The object underlying the invention is also achieved by an imaging device for providing three-dimensional or four-dimensional images of an object with reduced position-related gray value variations, comprising a control and evaluation system for the registration of image data sets afflicted with position-related gray value variations. By carrying out one of the aforementioned methods it is possible for the imaging device according to the invention to cause a reduction or correction, respectively, of the position-related gray value variations. As a matter of course, it is possible that the imaging device according to the invention is integrated into a corresponding magnetic resonance scanner or computer tomograph. However, the reduction of the position-related gray value variations according to the invention may also be achieved by means of a separate device which is not connected to the corresponding tomographs or scanners.

Further advantages, features and particularities of the invention result from the following exemplary, however non-limiting, description of preferred embodiments of the invention. The Figures show:

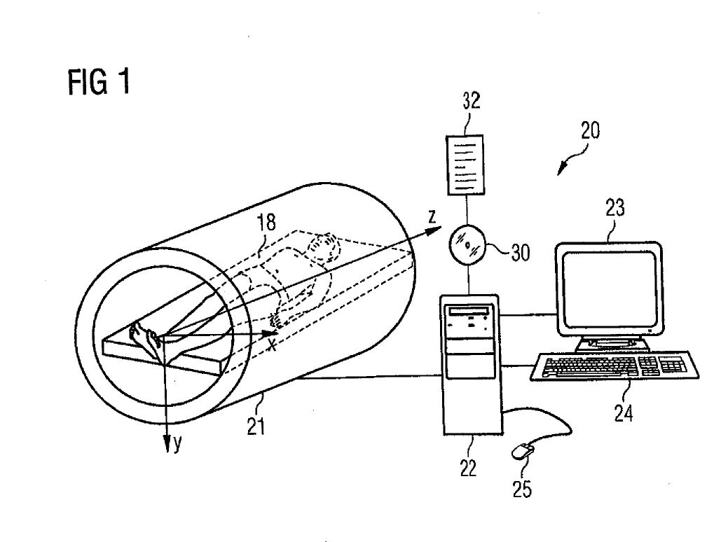

FIG. 1 shows an imaging device according to the invention in combination with an MR scanner,

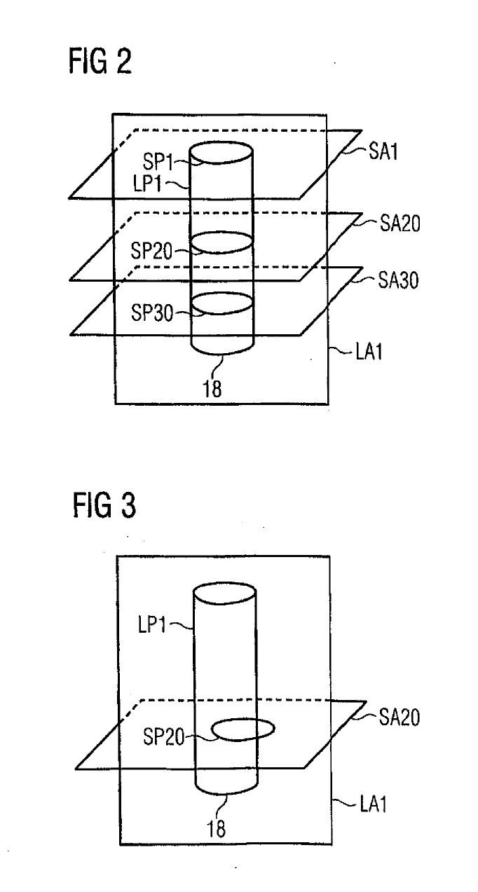

FIG. 2 shows a schematic view of a long-axis section, three short-axis sections as well as a left ventricle, as it should be ideally depicted in the short axis or in the long axis, respectively, in perfect registration,

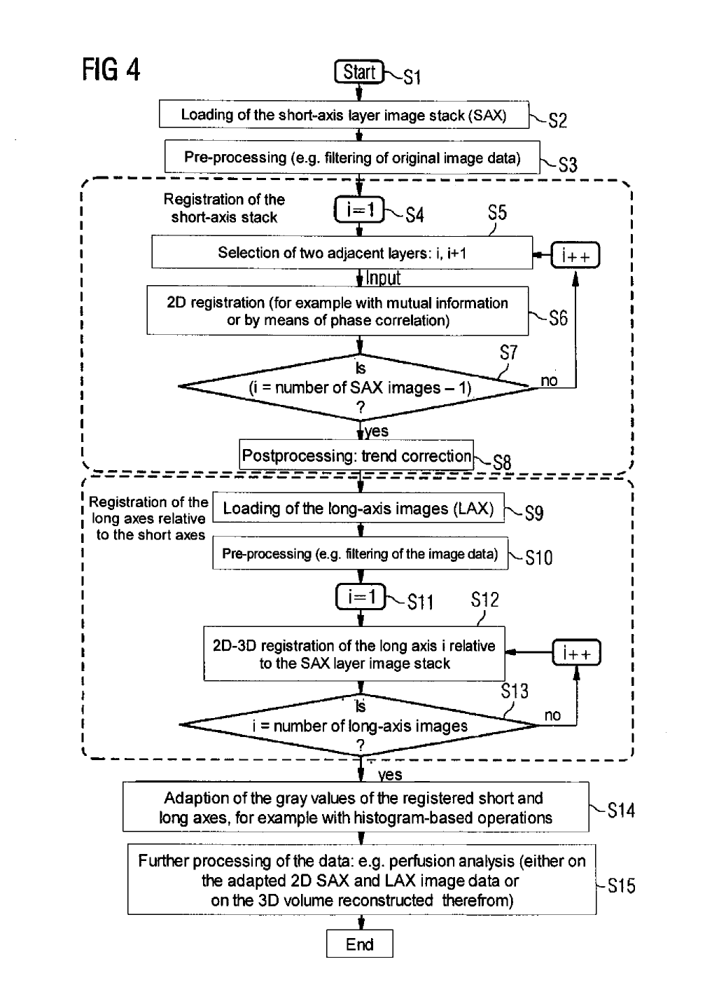

FIG. 3 shows a schematic view of a short-axis section as well as of a long-axis section and a left ventricle, as it is depicted in the short-axis section in the case of faulty registration,

FIG. 4 shows a schematic view of a program flow chart for the registration with subsequent adjustment of the gray values and further processing of the data, and

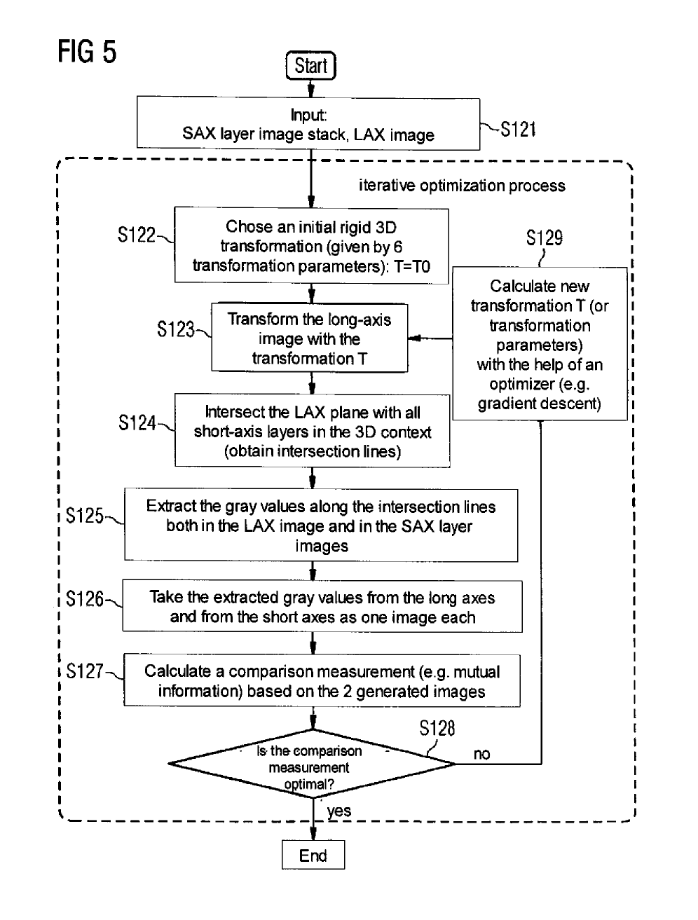

FIG. 5 shows a schematic view of a program flow chart of the registration of the long axis relative to the short-axis stack, and

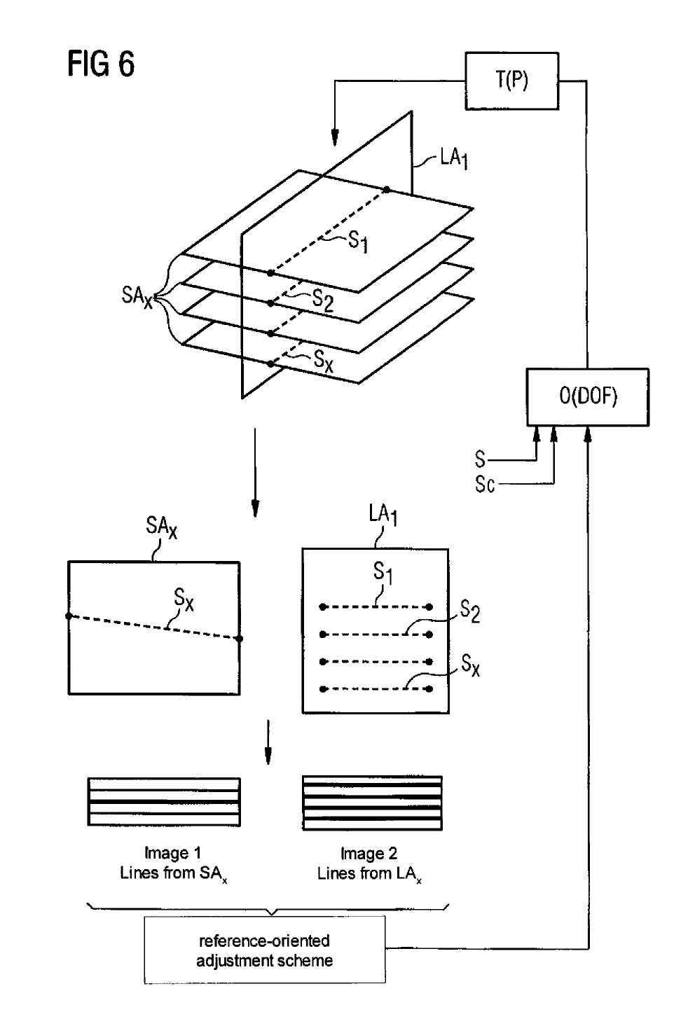

FIG. 6 shows a schematic view of the program sequence with the help of schematically indicated sectional planes.

According to the schematic representation of FIG. 1 a patient is inserted into the MR scanner 21 along the z axis, which is agreed to be the longitudinal axis of an MR scanner 21. Here, the x axis and the y axis, which are perpendicular to the z axis, represent the xy plane. An imaging device 20 is connected to the MR scanner 21, which imaging device 20 comprises a computer 22, a monitor 23, a keyboard 24 as well as a mouse 25. The MR scanner 21 may also be seen as a part of the imaging device 20. By means of a data carrier 30, which is symbolically depicted as a CD ROM here, it is possible to load a computer program 32 stored thereon into the computer 22. The MR scanner, as a rule under the control of the computer 22, produces a series of MR image data sets of the heart in different layers SA1, SA2, . . . , SAn, which are referred to as short-axis stacks. Here, in each layer a first picture SP1, SP2, . . . , SPn is generated, moreover in at least one plane intersecting with the first layers, preferably however two or three of said planes, which are referred to as long-axis sections LA1, LA2 and LA3, respectively, second pictures LA1, LP2 and LP3, respectively, are generated. If there are two long-axis sections, they preferably are arranged at an angle of 90° relative to each other, and if there are three long-axis sections, the angle between them is preferably 60°. The coordinate system shown is that to which the positional data of the individual images refers as so-called DICOM tags or DICOM data.

If different axial sections are made and recorded, there are practically always artifacts in the reconstruction since, on the one hand, it is never possible to acquire the pictures perfectly. In the simplest case, at least 5 to 16 sections are required to sufficiently capture the heart. In the standard case, slices of 1 cm are made. As a result, depending on the size of the heart, between 10 and 15 short-axis sections and 3 long-axis sections are made. On the other hand, the object which is to be recorded and depicted, as a rule is located in different positions when the individual pictures are acquired, which is generally the case in particular in the case of fast-moving objects such as a heart or its surrounding area. This means that the depiction of the left ventricle 18, for example, in the long-axis section L1 does not “fit” the depiction in the short-axis sections, as is schematically shown in FIG. 3 for the short-axis picture SP20. This means in other words that the cross-sections in the short-axis stack are offset relative to the longitudinal section in the long-axis section, as is schematically indicated in FIG. 3. In comparison, FIG. 2 shows for the short-axis pictures SP1, SP20 and SP30 what the depiction would have to look like in the case of a perfect registration between short-axis stack and long-axis section.

Hereinafter, with reference to the flow charts shown in FIG. 4 and FIG. 5, it is shown how a respective registration is carried out according to the invention. This explanation for the sake of example is based on the assumption that there is a short-axis layer image stack with a plethora of layers, while there is only a small number of long-axis sections. As a matter of course, it is also possible that there is a plethora of long-axis sections and considerably fewer short-axis sections. However, this does not decisively influence or even negatively affect the functioning of the method according to the invention.

After the process has been started in step S1, the short-axis layer image stack or short-axis stack, respectively, is loaded in step S2. Prior to the actual registration, a so-called pre-processing is carried out in step S3, in which for example the original image data is filtered in order to remove noise and, thus, to improve the image quality.

In step S4, at first an indexed variable i is set to 1, thereafter, in step S5, the first two adjacent layers are selected. Said two layers are registered in step S6, for example by means of a parametric registration method with mutual information as comparison measurement or a registration method based on phase correlation. In step S7, it is then checked whether already all layers of the short-axis stack are registered relative to each other. If this is the case, then, in step S8, preferably a so-called post-processing or subsequent processing is carried out in order to correct a trend, which may easily form when registering the layer image stacks. If in step S7 not yet all layers of the short-axis stack have been captured as registered with one another, the indexed variable i is increased or incremented by 1, and the method is continued with step S5, so that then the next two layers are registered with one another. Steps S4 to S8 describe the registration of the short-axis stack, which is schematically indicated by a corresponding broken frame. Then, in step S9 the long-axis pictures are loaded into the computer 22. Similar to step S3 a pre-processing is carried out, namely in step S10. Then, in step S11, the indexed variable i is set to 1 for this part of the registration. In step S12, a 2D-3D registration of the long axis i relative to the short-axis stack is then carried out.

The individual steps forming step S12 are shown in FIG. 5. To this end, in step S121, the short-axis stack as well as a long-axis picture is input into the computer 22. Then, in step S122, at first an initial rigid three-dimensional transformation is chosen which is given by six transformation parameters and the scanner geometry. This transformation T is initially referred to as T10. Then, in step S123, the long-axis image is transformed with the transformation, thereafter in step S124 the long-axis plane is intersected with all short-axis layers in the three-dimensional context, i.e. with planes intersecting in space. As a result, corresponding intersection lines are obtained. Finally, in step S125, the gray values are extracted along the individual intersection lines both in the long-axis image and in the short-axis images. Here, the extracted gray values from the long axes and the short axes in step S126 are considered to be one image each, which makes it possible to calculate in step S127 a comparison measurement between two respective generated images. For calculating the comparison measurement, for example mutual information is used. Finally, in S128 it is checked whether the comparison measurement is sufficient and/or even optimal. If this is not the case, a new transformation T or new transformation parameters, respectively, are calculated in step S120, namely with the help of an optimization method. Example of such optimization methods are the gradient descent method, a Powell optimizer or also the downhill simplex method. Then, step S123 is again carried out with the new transformation T or the new transformation parameters, respectively, and the long-axis image is transformed with the new transformation T. This iterative optimization process is then carried out until in step S128 it is determined that the quality level required by the comparison measurement is fulfilled. Once this is the case, the iterative optimization process defined by the steps S122 to S129, which is schematically indicated by a broken frame, is over.

The process continues then with step S13 and checks whether all long-axis images have been registered relative to the short axes. If this is not the case, then the indexed variable i is increased or incremented by 1, and step S12 (or steps S121 to S129, respectively) is repeated until all long axes are registered relative to the short axes. Steps S9 to S13 denote the registration of the long axes to the short axes, which is schematically indicated by a corresponding broken frame. Only after the long-axis images have been completely registered relative to the short-axis images (and not already before, as is the case in the prior art)—i.e. when an exact attribution of the common structures is known—will the gray values be adjusted to the registered short and long axes. Preferably, the adjustment is carried out with histogram-based operations—i.e. on the basis of the entire image or an area of interest or a region of interest (ROI). As possible variants for said adjustment, the following have to be mentioned: The gray values of the short axes are adjusted to the gray values of the long axes, or the gray values of the long axes are adjusted to the gray values of the short axes. Alternatively, it is also possible to adjust all images to a common base value or reference value. Such a common reference value may for example be a mean value of the gray values over the entire image. It becomes apparent from the foregoing description that the essence of the invention can be found in step S14.

As soon as the registrations have been carried out and the gray values have been attributed, it is possible to three- or four-dimensionally further process the image data acquired in this way in step S15. For example, a perfusion analysis may be conducted which is either based on the adjusted two-dimensional short-axis and long-axis image data or also on the three-dimensional volume image data set reconstructed therefrom. If the temporal development of the reconstructed three-dimensional image data set is additionally taken into consideration, even a four-dimensional further processing of the data is possible.

FIG. 6 shows the schematic sequence of the program with the help of schematically shown intersecting planes. Several first layers (SAx) are intersected by a second layer (LA1) intersecting with said layers. The resulting intersection lines (S1, S2, . . . , Sx) are schematically shown in a first layer (SA1) and in the one second layer (LA1). From said intersection lines of the respective first layers (SAx) and the several intersection lines (S1, S2, . . . , Sx) from the one second layer (LA1) result two images which may be used as a basis for a reference-oriented adjustment scheme (similarity measurement). Said similarity measurement is fed to a corresponding optimizer 0 (D0F) which when adapts the registration to the respective first pictures via a function T(P), in that said function T(P) is paremeterized either with three or six degrees of freedom (D0F) and provided accordingly with data by the optimizer 0 (D0F). In addition, a corresponding start value S and a scaling factor Sc are transmitted to the optimizer. Then, the process is repeated and the registration of the respective first layers (CAx) is successively optimized by means of the respective adapted parameters P and the function T(P)

It should be observed that the comparison measurement mutual information does not directly operate on the juxtaposed extracted gray values of short axes and long axes, but takes into consideration the gray value distribution of the entire image or of a limited image area.

The comparison measurement “mutual information” comes from information theory and, independent of the absolute gray values, measures the information which occurs both in an image 1 and in another image 2. Here, instead of juxtaposing gray values pixel-wise, only the frequency of gray value combinations in the underlying images is considered. As entropy the transinformation (mutual information) describes how much the knowledge of the one image reduces the insecurity with respect to the other images (cf. Mutual information based registration of medical images: a survey”; Josien P. W. Pluim, et al., IEEE Transactions on Medical Imaging, Vol. XX, No. Y, Month 2003).

It has to be noted that the method according to the invention makes it possible to iteratively or recursively carry out the registration and gray value adaption. Here, if necessary, it may be provided that only small changes for example in the transformations or in the adaptions of the gray values may be made. Here, by means of iteration it is possible to further increase the quality of the image improvement.

In the foregoing, reference was only made to the gray values in the individual pictures. However, as a matter of course, the method according to the invention is also applicable when the individual pictures cannot be generated as gray value images but are encoded in different color values. However, the basic procedures of the invention remain untouched, account has only to be taken of the respective color values. Generally, it has to be noted that the method according to the invention may be employed for any representation of measured values.

Finally, it has to be noted that the features of the invention described with reference to the embodiments shown and described, such as type and position of the individual sectional and imaging planes and the design of individual details of the registration and image processing operations, may also be present in other embodiments, except this is otherwise indicated or technically unfeasible.

1. A method for reducing in particular position-related gray value variations of image data sets of an object (18), in particular of a heart, which are recorded in various first layers (SA1, SA2, . . . , SAn) as respective first pictures (SP1, SP2, . . . , SPn) and in at least one second layer (LA1) intersecting with at least one first layer (SA1, SA2, . . . , SAn) as a respective second picture (LP1), comprising the following steps:
registering the respective first pictures (SP1, SP2, . . . , SPn) of the first layers (SA1, SA2, . . . , SAn) relative to each other and with the at least one second picture (LP1) of the at least one second layer (LA1) in order to associate the first pictures (SP1, SP2, . . . , SPn) and the at least one second picture (LP1) of the object (18) with each other, and
adjusting the gray values of the object (18) in the at least one second picture (LP1) to the gray values of the object (18) in the first pictures (SP1, SP2, . . . , SPn) based on a reference-oriented adjustment scheme, wherein the reference-oriented adjustment scheme in particular especially considers or is limited to the intersection area of the respective first picture (SP1, SP2, . . . , SPn) with the at least one second picture (LP1).

2. The method according to claim 1, wherein for the reference-oriented adjustment scheme the respective mean value of the gray values in the intersection area of the respective first picture (SP1, SP2, . . . , SPn) with the at least one second picture (LP1), in particular the two-dimensional intersection line of three-dimensional intersection volume thereof, is used.

3. The method according to any one of the preceding claims, wherein the first layers (SA1, SA2, . . . , SAn) form a short axis stack of a random chamber of a heart (18) and the at least one second layer (LA1) is a long-axis section of said chamber of the heart (18).

4. The method according to claim 3, wherein the random chamber of the heart (18) is the left ventricle (19).

5. The method according to any one of the preceding claims, wherein prior to the registration of the respective first pictures (SP1, SP2, . . . , SPn) relative to each other and/or prior to the registration of the registered first pictures (SP1, SP2, . . . , SPn) with the respective at least one second picture (LP1) a pre-processing is carried out, in particular in the form of filtering the image data.

6. The method according to any one of the preceding claims, wherein the adjustment is conducted with histogram-based operations.

7. The method according to any one of the preceding claims, wherein in the registration of the respective first pictures (SP1, SP2, . . . , SPn) with the respective second picture (LP1) one respective intersection line or an intersection volume, respectively, in the corresponding first picture (SP1, SP2, . . . , SPn) and in the corresponding second picture (LP1) is calculated, along which the respective gray values are extracted and treated as an image, on the basis of which a comparison measurement between the two images is calculated.

8. The method according to any one of the preceding claims, wherein the registration of the respective first pictures (SP1, SP2, . . . , SPn) with the respective at least one second picture (LP1) is iterated or repeated if the comparison measurement fulfills an iteration criterion.

9. The method according to claim 8, wherein the iteration criterion is the shortfall below a certain threshold value or the exceeding of a defined difference of the comparison measurement between two iterations.

10. The method according to any one of the preceding claims, wherein only small changes are permitted when adjusting the gray values, wherein the registration and the adjustment of the gray values is carried out recursively.

11. Computer program product (32) for a control and evaluation system of an imaging device for providing three-dimensional or four-dimensional images of an object (18) with reduced, in particular position-related gray value variations, for carrying out a method according to any one of the preceding claims.

12. A data carrier (30) with a computer program product according to claim 11 stored thereon.

13. An imaging device (20) for providing three-dimensional or four-dimensional images of an object (18) with reduced, in particular position-related gray value variations,
comprising a control and evaluation system for the registration of image data sets of an object (18) afflicted with position-related gray value variations, for controlling the imaging device (20) according to a method according to one of claims 1 to 10.
